(19) United States
(12) Patent Application Publication
(10) Pub. No.: US 2007/0265984 A1
(43) Pub. Date: Nov. 15, 2007

(54) Financial transaction using mobile devices

(76) Inventor: Prakash Santhana, Amawalk, NY (US)

Correspondence Address: Ashok Tankha;Of Counsel, Lipton Weinberger & Husick, 36 Greenleigh Drive, Sewell, NJ, 08080, US

(21) Appl. No.: 11/409,943

(22) Filed: Apr. 24, 2006

(51) Int. Cl. H04L 9/00

(52) U.S. Cl. 705/65

(57) ABSTRACT

A method and system is disclosed herein for conducting money or value point transactions between a first mobile device and a second mobile device in a network of a plurality of mobile devices. Each mobile device contains a radio frequency identification module with a digital wallet on each said mobile device for storing and processing digital value points. Digital certificates are provided in each mobile phone for the purpose of authenticating the mobile devices. The transaction is initiated by the first mobile device with the second mobile device by exchanging RFID identifiers and digital certificates via radio frequency identification transmission and reception. Digital certificates can be exchanged between the digital wallets of the first and second mobile devices using radio frequency transmission. The method and system disclosed herein allows users equipped with RFID enabled mobile devices to transact over a short range without a need for connectivity to a banking infrastructure or a central network.

### BACKGROUND

This invention, in general, relates to financial transactions between two or more parties over mobile devices and in particular relates to peer to peer financial transactions using mobile devices that contain radio frequency identification (RFID) with a unique identifier. In one embodiment of the invention, this method relates to financial transactions that involve payment for goods or services purchased.

The rapid proliferation of mobile devices with extended computing capabilities has created a market for mobile device based monetary transactions. New business transaction models such as online payments, mobile banking, micro payments, credit payments, etc., are replacing conventional cash transaction methods.

Success factors for existing electronically enabled transactions include the capability of authentication of the transacting parties, and the connectivity of the transacting parties to a centralized banking infrastructure. Existing transaction methods using mobile devices involve authenticating a payer and a payee with a centralized banking infrastructure, and sending the transaction details over a communications network to a central server that hosts the banking infrastructure. Thus, if two mobile devices were to carry out transactions with each other, there is a dependency on the communication network for authenticating and communicating with the banking infrastructure. Although there is an option for the payee to transfer money to his or her account directly through the use of net banking or mobile banking facilities, there is a need to obtain cash electronically to his or her mobile device without having to visit the bank, or without having to contact the banking infrastructure.

Although traditional electronic banking tools such as credit cards or debit cards eliminate the need to carry cash, they require connectivity to a central server for authentication and transaction processing. Hence, credit cards and debit cards are poor choices for implementing a wholly electronic transaction method that will help customers make business transactions irrespective of their location and the connectivity to communication infrastructures.

Cash will continue to remain as the biggest competition to credit cards, debit cards and other payment systems. The reason for this is that cash is familiar, ubiquitous and is universally accepted. However, the use of cash for payment requires that a user either carry large amounts of cash in their wallet, or the user make frequent trips to an ATM or a bank. Therefore, there is an unmet market need for enabling peer to peer cash transactions with devices that will allow customers to transact with more ease than they would with hard currency. Cash can also be stolen resulting in loss. Thus, there is a need for a transaction system that protects users from loss if the means of transactions are lost or misappropriated.

Credit card associations such as American Express, Visa and MasterCard are currently developing cell phone based credit and debit payment solutions. These payments are based on existing debit and credit networks, and allow customers to store their debit and credit accounts in so-called mobile phone wallets. However, the challenge is to create a standardized mobile wallet that could store credit and debit numbers from all the card associations. Additionally, credit card associations have difficulty in weaning themselves away from card based payments due to branding issues. Finally, the solutions proposed by the card associations do not target the unbanked population, i.e., users who do not have a bank account or a credit card account. There is a market need to address the transaction needs of the unbanked population.

Thus, there is an unmet market need to authenticate the payer and the payee and process transactions on a peer to peer level without the need for connectivity to a central server hosting a banking infrastructure.

### BRIEF DESCRIPTION OF THE DRAWINGS

Embodiments will now be described, by way of example only, with reference to the attached Figures.

FIG. 1 illustrates a method of conducting a transaction between a first RFID enabled mobile device and a second RFID enabled mobile device in a network of a plurality of mobile devices.

FIG. 2A illustrates a system for conducting a transaction between a first mobile device and a second mobile device in a network of a plurality of mobile devices.

FIG. 2B illustrates the components of the RFID enabled mobile device.

### DETAILED DESCRIPTON OF THE DRAWINGS

The method and system disclosed herein facilitates a guaranteed payment system that allows a customer to store monetary value on an RFID cell phone and use the system to send or receive money from another similarly equipped cell phone or a radio frequency identification reader/writer. A customer first establishes a primary reserve account and links the primary reserve account with any number of RFID enabled cell phones. The customer may link the primary reserve account with a debit/credit account or a pre-paid debit card account. The purpose of the primary reserve account is to provide immediate access to cash to make a peer to peer micro payment, i.e., make proximity payments even in the absence of network connectivity, or to enable remote money transfers between two reserve accounts. The value in the primary reserve account can either be created by transferring money from a bank account, or by uploading accumulated values from RFID enabled cell phones associated with the primary account.

The method and system herein allows a customer to convert a part of the primary reserve account value into foreign currency of choice and to set up a foreign currency reserve account to facilitate remote or proximity payments.

The method and system herein also allows both the banked and the unbanked population to make cell phone based peer to peer micro payments.

The method and system herein also allows a financial transaction to be conducted between a first mobile device and a second mobile device in a network of a plurality of mobile devices, wherein each mobile device contains a radio frequency identification device with an identifier.

The method and system herein also allows an RFID enabled mobile device to make credit transaction with a similar RFID enabled mobile device.

The method and system herein also allows a RFID enabled mobile device to transact money with a RFID enabled automated teller machine.

The method and system herein also allows users within an organization to transact digital points using RFID enabled mobile devices.

The method and system herein also allows an authorized user to use a RFID enabled mobile device to connect to the internet and conduct online transactions with sellers via the world wide web.

The method and system herein also allows a user to use a RFID enabled mobile device to purchase digital content and store such content on the mobile device. Examples of digital content include photographs, music, games, etc.

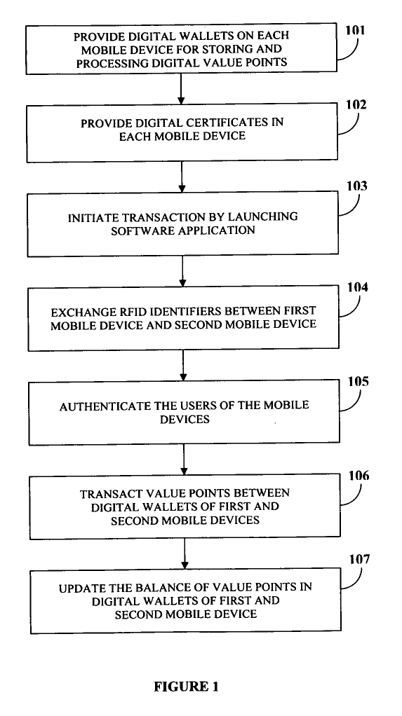

FIG. 1 illustrates a method of conducting a transaction between a first RFID enabled mobile device and a second RFID enabled mobile device in a network of plurality of mobile devices.

Each RFID enabled mobile device is equipped with a radio frequency identification module that provides a unique identifier for each mobile device, and also serves as a communication means for conducting a transaction between mobile devices. The software application that performs the transactions over the RFID interface is downloaded onto the mobile device from the software application provider via a personal computer connected to the internet, or directly via the web-enabled mobile device. The process of downloading the application onto the mobile device initializes an electronic wallet in the mobile device 101. The users of the mobile devices are provided with digital certificates that uniquely identify each user 102. The user of the first mobile device initiates a transaction with the second mobile device by launching the downloaded application in the mobile device. Upon launching the software application in the first mobile device 103, a transaction request is sent from the first mobile device to the second mobile device. The transaction request includes the unique RFID identifier and the unique digital certificate of the first mobile device. Upon receiving the transaction request from the first mobile device, the second mobile device checks the authenticity of the RFID identifier sent by the first mobile device. The digital certificate received from the first mobile device via radio frequency communication, is verified by the second mobile device. If the RFID identifier and the digital certificate provided by the first mobile device are determined to be valid, the second RFID device responds by transmitting a reply authorizing the transaction with the first mobile device. The reply from the second mobile device includes the unique RFID identifier and the digital certificate of the second mobile device. The first mobile device upon receiving the RFID identifier and the digital certificate from the second mobile device verifies the authenticity of the RFID identifier and the digital certificate of the second mobile device 105. If the RFID identifier and the digital certificate provided by the second mobile device are determined to be valid, the first mobile device authenticates the transaction with the second mobile device. Upon confirming the identity of the second mobile device, the user of the first mobile device provides information on the transaction, for example, the user of the first mobile device inputs the amount of digital value points that is to be transferred from the first mobile device to the second mobile device. The input to the first or second mobile device can be one or more of the following modes: keypad input, voice input, haptic input, or input through a stylus.

The user of the second mobile device then confirms the request to transfer the digital value points to the second mobile device. Upon receiving the confirmation from the second mobile device to transfer digital value points to the second mobile device, the first mobile device transfers the digital value points specified by the user of first mobile device to the second mobile device 106. After the transaction between the first mobile device and the second mobile device is complete, the balance of digital points in the electronic digital wallets of first and second mobile devices are updated 107.

The following example illustrates the process of transacting cash between two mobile devices among a plurality of mobile devices. Consider two users A and B with cell phones, each equipped with a unique radio frequency identification device with the downloaded software application. User A and user B are connected to a global system for mobile (GSM) based communications network; in addition, they can communicate with each other in near range using RFID. The communications network is in communication with the internet that hosts servers for the banking infrastructure and the software application provider. The software application provider provides the application that is used to manage the process of conducting a transaction between the RFID enabled cell phones. The users need to register with the software application provider prior to downloading and installing the software application onto their cell phones. User A and user B then download the application from the software provider onto their cell phones. Each user is then assigned a primary account that links to the corresponding mobile wallet of each user's cell phone. After the users have registered with the software application provider, the software application provider assigns to each mobile device a unique digital certificate that is downloaded and stored in the cell phones.

When user A wishes to conduct a transaction with user B, user A and user B launch the software application on their respective cell phones. After the application is launched on both the mobile devices, the cell phone of user A transmits via radio frequency, the unique RFID identifier and the digital certificate to validate its identity with the cell phone of user B. The cell phone of user B receives the RFID identifier and the digital certificate from mobile phone of user A, and upon authenticating the cell phone of user A, transmits its own unique RFID identifier and digital certificate via radio frequency to the cell phone of user A. Upon successful validation of both the cell phones, user A types in a personal identification number (PIN) and enters, for example, $20 to be sent user B. When user A confirms the transfer of cash to user B, the software application in the cell phone of user A checks with the electronic digital wallet of A to check if the $20 monetary value is available in its electronic digital wallet. If money is available in the electronic digital wallet of user A, the application in cell phone A scans for cell phone B, and locks in on the radio frequency of cell phone B. Upon locking, a message is transmitted from cell phone A to cell phone B indicating an incoming payment and the amount of the payment. Upon receiving the message, the user of cell phone B accepts or declines the payment. The software application in the mobile phone of user B provides options for user B to accept or decline the payment that is being transmitted by user A. If the payment is accepted by the user B on his/her cell phone, a message is displayed on the cell phone of user A to confirm the payment to user B. When user A confirms payment, a message is displayed on both the cell phones of A and B that a payment has been made or received. The electronic digital wallets of cell phones A and B are immediately updated to reflect a debit and a credit, respectively.

In the event $20 is not available in the digital wallet of user A, or in the primary reserve account of user A, the application prompts user A to download cash using a debit/credit card or a pre-paid debit card linked to the primary account. If user A chooses to download cash onto the cell phone using a debit/credit card or a pre-paid debit card, then user A chooses the debit or a pre-paid debit card account and the corresponding PIN assigned to the debit/credit card, or the pre-paid debit card by the card issuer into the application to enable a withdrawal. This withdrawal can be effected by logging on and transacting to a banking system server via the internet, using the GSM communication link.

The following example illustrates the method and the system of this invention in a corporate network of mobile devices. The digital value points exchanged between two or more radio frequency identification enabled mobile devices is limited for use within the organization. Digital value points are first transferred to the mobile devices by a corporate administrator. The corporate administrator is also responsible for providing the application software and the digital certificates that uniquely identify each user of the network. The digital points can be exchanged for goods or services authorized by the corporation or organization.

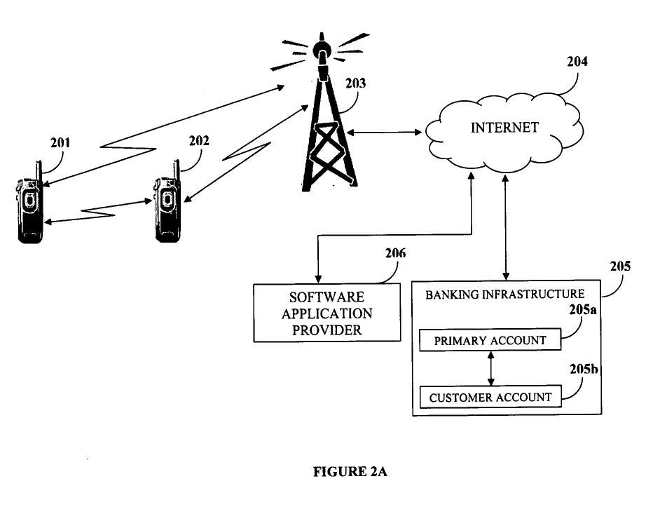

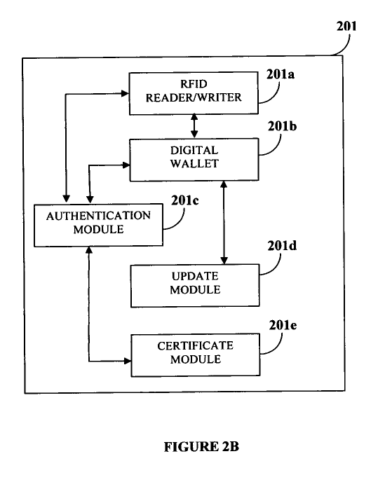

FIG. 2A illustrates a system for conducting a transaction between a first mobile device and a second mobile device in a network of a plurality of mobile devices. The system comprises of a plurality of mobile devices 201 and 202, each equipped with radio frequency identification (RFID) and connected to a communication network 203. The communication network 203, the software application provider 206 and the banking infrastructure 205 are connected to the internet 204.

Each RFID enabled mobile device is equipped with a radio frequency identification device with an identifier that uniquely identifies each mobile device. The software application necessary for performing the transactions over the RFID interface is downloaded onto the mobile device from the software application provider 206. The process of downloading the application onto the mobile device initializes an electronic digital wallet on the mobile device. The users of the mobile devices are provided digital certificates by the software application provider that uniquely identifies each user of the system. Each mobile device is further provided with a primary account 205a that is linked to the customer account 205b. Each customer account 205b is associated with a unique customer. Each primary account 205a can be configured to be used by a plurality of users, each equipped with a mobile device.

The communication network is inclusive of, but not restricted to systems, for example, a wireless, global system for mobile communications (GSM), code division multiple access and satellite communication system network, for example the ORBCOMM® communication system of ORBCOMM, Inc., etc.

FIG. 2b illustrates the components of the mobile device. Each mobile device contains a radio frequency identification device with a unique identifier. The mobile device 201 comprises of a RFID reader and writer 201a, RFID transmitter, RFID receiver, digital wallet 201b, memory within the digital wallet 201b for storing transaction information, an authentication module 201c, an update module 201d, a certificate module 201 and the typical communication and computation modules that are contained in cell phones.

The RFID reader and writer 201a is capable of accepting data or writing data onto a RFID device. When an amount of digital points is transferred to the first mobile device 201 from the second mobile device 202, the RFID reader 201a receives the data from the second mobile device 202. The RFID reader and writer 201a is in communication with the digital wallet 201b and the authentication module 201c. The digital points from the second mobile device 202 downloaded from a reserve account or received from another mobile device, are stored in the digital wallet 201b as a result of this transaction.

The authentication module 201c is responsible for validating the identity of the transacting mobile device. The authentication module is connected to the RFID reader and writer 201a, the electronic wallet 201b, and the certificate module 201e. The authentication module further contains a database for storing digital certificates and RFID identifier information of mobile devices that are permitted to perform transactions or an algorithm to verify that the digital certificates or the RFID identifier of the transacting device is valid. Mobile devices that may conduct peer to peer transactions are registered with the software application provider. Whenever a first mobile device 201 initiates a transaction with a second mobile device, the authentication module provides the unique identifier and the digital certificate of the mobile device 201 to the RFID transmitter of the mobile device. The RFID transmitter then transmits the authentication information via radio frequency to the second mobile device. If the second mobile device 202 validates the identity of the mobile device 201 and replies with its own unique identifier through its RFID transmitter, the first mobile device compares the identifier and the digital certificate provided by the second mobile device 202 to the identifier and the digital certificate stored within the certificate module 201e of the first mobile device 201. The authentication module 201c, may also verify the validity of the digital certificate and the unique identifier.

The update module 201d updates the digital wallet in the mobile device 201 after the completion of a transaction. After the first mobile device 201 has completed a transaction with a second mobile device 202 either by transferring an amount of digital points or by receiving digital points from a second mobile device 202, the update module 201d calculates the amount of digital points received or transferred and thereafter deducts or credits that amount from the digital wallet in the first mobile device 201.

In one embodiment of the method described in FIG. 1, the first mobile device is an RFID enabled mobile phone, herein mobile phone, and the second mobile device is an RFID enabled automated teller machine (ATM). The mobile phone user associates a customer account on the banking infrastructure with the primary account. The primary account can then be linked to any number of RFID enabled mobile phones authorized by the user. Thus a single primary account can be used to serve a group of individuals, for example individuals within a family. The users then download the software provided by the software application provider that is necessary for conducting a transaction via the mobile phone. When all the money in the digital wallet of the mobile device has been spent, the user of the mobile device has the choice of downloading cash from either the primary account by communicating with the banking infrastructure, by obtaining electronic cash from other mobile devices, or by obtaining cash through an RFID enabled ATM.

The following description details the process of recharging the digital wallet using an RFID enabled ATM. The user launches the software application in the mobile device to initiate a transaction between the mobile device and the ATM. The user issues a request for transaction with the ATM. An RFID identifier and a digital certificate which uniquely identifies the mobile device is transmitted to the ATM. The ATM checks the RFID identifier and the digital certificate for authenticity by comparing against its pre-stored list of authorized users, and responds by transmitting its RFID identifier and a digital certificate. The mobile device checks the RFID identifier and the digital certificate from the ATM for authenticity. If both the ATM and the mobile device successfully authenticate each other, the mobile device issues a request to the ATM for an amount of cash specified by the user. The ATM checks the amount of cash available against the primary account of the user, and if sufficient cash is available, the ATM transfers the cash to the digital wallet in the user's mobile device via radio frequency. After the transaction is complete, the cash balance in the user's mobile device and the ATM are updated.

In another embodiment of the invention, the present method allows a user of an RFID enabled mobile device to conduct buy and sell transactions via a computer connected to the internet. This online transaction system would comprise of an RFID enabled mobile device, a computer equipped with an RFID device, the internet and the server of the service provider. The service provider is the supplier of the goods and services.

The user of the mobile device launches the application in the mobile device for initiating the online transaction. The mobile device issues a request to the computer by transmitting its RFID identifier and a digital certificate. The RFID device on the computer checks the authenticity of the RFID identifier and the digital certificate by comparing the RFID identifier and the digital certificates stored in its authentication module and responds by transmitting its own RFID identifier and digital certificate. If the mobile device and the computer successfully authenticate each other, the user of the mobile device is permitted to conduct buy and sell transactions, based on the monetary value available in the digital wallet, by transferring electronic cash via radio frequency transmission.

In another embodiment of the invention, the user of an RFID enabled mobile device running the application software has the option to transact in multiple foreign currencies. Different amounts of digital points can be stored to correspond to different currencies in the digital wallet of the mobile device. Digital points stored against a particular currency indicator correspond to the currency of a particular country, and tagged to a unique currency indicator.

In another embodiment of the invention, the user of a RFID enabled mobile device running the application software can purchase digital content and store such content on the mobile device. Examples of digital content include photographs, music, games, etc.

The foregoing examples have been provided merely for the purpose of explanation and are in no way to be construed as limiting of the present method or system disclosed herein. While the invention has been described with reference to various embodiments, it is understood that the words which that have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention.

I claim:

1. A method of conducting a transaction between a first mobile device and a second mobile device in a network of a plurality of mobile devices, wherein each mobile device contains a radio frequency identification module with an identifier, comprising the steps of:
providing digital wallets on each said mobile device for storing and processing digital value points;
providing digital certificates in the first mobile device and the second mobile device;
initiating a transaction by said first mobile device with said second mobile device;
exchanging radio frequency identification identifiers between the first mobile device and the second mobile device via radio frequency identification transmission and reception;
authenticating the unique identity of the second mobile device by the first mobile device using said received radio frequency identification identifier from the second mobile device;
transacting value points between the digital wallet of the first mobile device and the digital wallet of the second mobile device, wherein said transaction is carried out using radio frequency identification transmission; and
updating the balance of digital value points in the digital wallet of the first mobile device and the digital wallet of the second mobile device.

2. The method of claim 1 wherein transacting value points comprises one or more of the following: transacting cash, transacting credit and transacting debit.

3. The method of claim 1, wherein the step of transacting value points further comprises the step of transacting value points for digital content which is transferred between the the first mobile device and the second mobile device through radio frequency communication, wherein the user of the first mobile device buys digital content from the user of the second mobile device.

4. The method of claim 1 wherein the mobile devices include mobile phones, hand held computing devices, computers, personal digital assistants and automated teller machines.

5. The method of claim 1 wherein said digital wallets store digital value points against its respective currency mode, and wherein transactions between two different currency modes further comprise the steps of determining the currency mode associated with said points accrued in the memory of the first mobile device by comparing the currency mode indicator associated with said points with a currency mode identifier contained in the transaction details stored in the memory of first mobile device, and determining a match between said identifier and said indicator.

6. The method of claim 2 wherein the method of conducting a credit transaction further comprises the steps of:
establishing a credit account associated with the primary account of the first mobile device;
receiving a request from the first mobile device to transmit a certain amount of digital points specified by the user of the first mobile device,
transferring said specified amount of digital points to the second mobile device by the first mobile device; and,
calculating and storing the amount of credit outstanding in the both the first mobile device and the second mobile device.

7. The method of claim 2 wherein the method of exchanging digital points that can be disbursed for goods and services within an organization between a first mobile device and a second mobile device in a network of plurality of mobile devices in an organization further comprises the steps of:
issuing digital points to the users of mobile devices within said organization, wherein said step of issuing digital points is performed by a controller module of said organization that is located on a server on the internet;
receiving a request from the first mobile device by the second mobile device to transmit an amount of digital points specified by the user of the first mobile device; and,
transferring digital points from the first mobile device to the second mobile device via radio frequency.

8. The method of claim 1, wherein the first mobile device and second mobile device transact with automated teller machines with in-built radio frequency identifier modules.

9. The method of claim 8 wherein the method of transacting cash between a first mobile device and an RFID enabled automated teller machine further comprises the steps of:
transmitting a digital certificate from the first mobile device to said automated teller machine for the purpose of identifying the first mobile device;
comparing a stored digital certificate in the automated teller machine to the digital certificate received from the first mobile device;
replying via radio frequency to the first mobile device of the successful execution of authentication process, if the stored digital certificate and the transmitted digital certificate from the first mobile device successfully match;
receiving a request from the first mobile device by the automated teller machine to transmit an amount of money specified by the user of the first mobile device; and,
transferring the amount requested in the form of digital value points by the automated teller machine to the first mobile device.

10. The method of claim 3 wherein the first mobile device can transact with a radio frequency enabled computer to perform on-line internet transactions.

11. The method of claim 1 wherein the step of updating the balance of digital value points in the first and second mobile devices further comprises the steps of:
determining the time and date of completion of the transaction by the first mobile device and the second mobile device;
associating said time and date of completion of transaction by the first mobile device with the monetary increment or decrement in the electronic wallet of the first mobile device and the second mobile device, and storing said associated information of time and date of completion of transaction and transaction information in the memories of the first mobile device and the second mobile device;
calculating the balance of digital value points in the first mobile device and the second mobile device after completion of the transaction between the first mobile device and the second mobile device;
storing the value of balance of digital value points in the memory of the first mobile device and the memory of the second mobile device; and,
updating the primary reserve accounts of the first mobile device and the second mobile device.

12. A system of conducting a transaction between a first mobile device and a second mobile device in a network of a plurality of mobile devices, comprising:
a plurality of mobile devices wherein each mobile device contains radio frequency identification device with a unique identifier, wherein the mobile device further comprises:
a radio frequency identification reader or writer capable of reading from or writing data into a radio frequency identification tag;
an electronic wallet for storing digital value points connected to said radio frequency identification reader or writer;
an authentication module for storing, comparing and authenticating the radio frequency identifier and digital certificate;
an update module for updating the balance of digital value points in the electronic wallet following a transaction of a radio frequency identification enabled mobile device with another radio frequency identification enabled mobile device, said update module being connected to the electronic wallet and the certificate module;
a certificate module for storing the radio frequency identification identifier and the digital certificate;
a communication network connecting the plurality of mobile devices to a primary account; and
a banking infrastructure connected to the internet further comprising a customer account that allocates cash to the primary account.

13. The system of claim 12 wherein the communications network is one or more of the following: advanced mobile phone service code division multiple access, global system for mobile communications, digital cellular telephone system, general packet radio service and time division multiple access networks.
